(19) United States
(12) Patent Application Publication
(10) Pub. No.: US 2001/0056388 A1
(43) Pub. Date: Dec. 27, 2001

(54) Data storage system

(76) Inventor: Masahito Yamazaki, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/878,937

(22) Filed: Jun. 13, 2001

(30) Foreign Application Priority Data
Jun. 27, 2000 (JP) 193331/2000
May 17, 2001 (JP) 148076/2001

(51) Int. Cl. G06F 17/60

(52) U.S. Cl. 705/32

(57) ABSTRACT

A data transmission apparatus charges a deposit for storing data in a data storage server. The data storage server pays back a deposit in response to an instruction of deleting data issued from a personal computer. The data transmission apparatus and data storage server are interconnected by a network. The deposit to be paid back is all the money amount of the deposit or the deposit reduced in accordance with a data storage period.

### BACKGROUND OF THE INVENTION

1. Field of the Invention

The present invention relates to a data storage system for transmitting and receiving data via a network.

2. Related Background Art

In sending a large amount of data such as image data to a particular destination, the data is transmitted as a file appended to an e-mail or the data is transferred as a file to a space of the server assigned to a recipient.

If image data is transmitted as an e-mail, it is directly stored in an individual mail spool of the server. If data is transferred as a file, it is stored in a space of the server assigned to an individual.

However, the storage capacity of a server assigned to an individual is generally limited. The above-described methods have therefore a limit in data amount capable of being transferred.

As a substitute service for a conventional copy machine of a coin charge type, many and unspecified persons scan images and the image data is transmitted in the form of an e-mail.

Other similar data transmission services are to transmit generated moving image data or to transmit data after its data format is converted.

Such services may be accompanied with a serious problem if the server which provides a mail spool of an individual person or a data space is attacked illicitly, because the size of data is large and the transmitter is very difficult to be identified.

### SUMMARY OF THE INVENTION

It is an object of the invention to ensure security of data storage.

It is another object of the invention to prevent a mail bomb.

The above and other objects of the invention will become apparent from the following description of embodiments.

### BRIEF DESCRIPTION OF THE DRAWINGS

FIG. 1 is a diagram showing the structure of a data transmission apparatus according to an embodiment of the invention.

FIG. 2 is a diagram illustrating a data flow of the data transmission apparatus according to the embodiment.

FIG. 3 is a diagram showing a command mail to a data storage server according to the embodiment.

FIG. 4 is a diagram showing a displayed dialogue to used for selecting a payment method for a deposit and selecting a notification method for a data storage ID according to the embodiment.

FIG. 5 is a flow chart illustrating a procedure to be executed by the data transmission apparatus according to the embodiment.

FIG. 6 is a block diagram showing an example of the data storage server according to the embodiment.

FIG. 7 is a flow chart illustrating a procedure to be executed by a data transmission apparatus according to another embodiment of the invention.

FIG. 8 is a diagram showing a displayed dialogue to be used for selecting a payment method for a deposit and selecting a notification method for a data storage ID according to the embodiment.

### DETAILED DESCRIPTION OF THE PREFERRED EMBODIMENTS

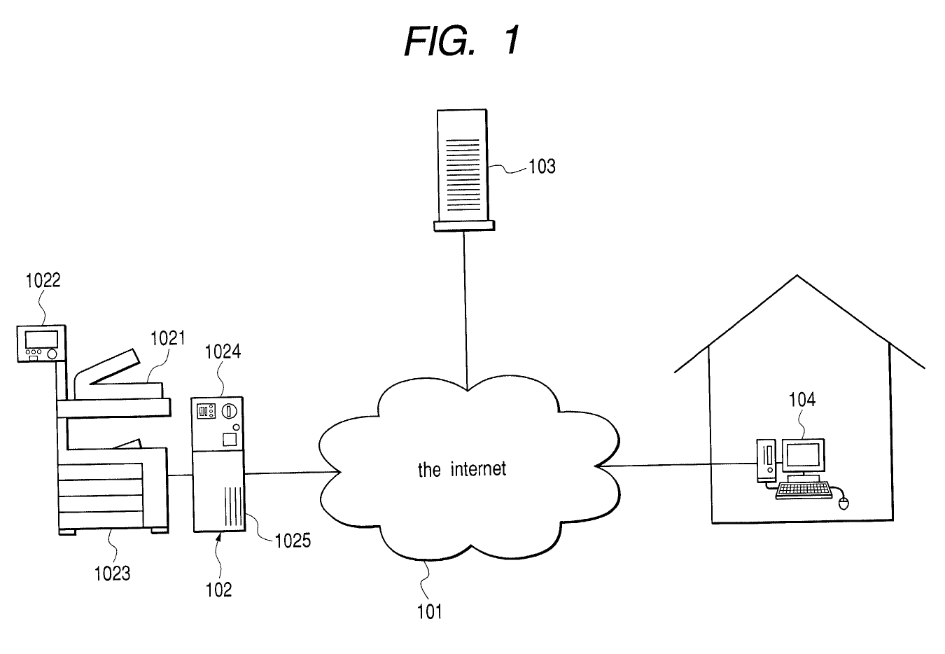

FIG. 1 is a diagram showing the overall structure of a data transmission apparatus to which the invention is applicable.

Referring to FIG. 1, reference numeral 101 represents the Internet. All data transmissions in this embodiment are preformed by using the Internet Protocol of the Internet 101. Other networks other than the Internet may also be used as transmission media.

Reference numeral 102 represents a data transmission apparatus which has: a scanner 1021 for scanning an image and generating image data; a panel unit 1022 having a display with a touch panel for performing various operations; a printer 1023 for printing when necessary; a charging unit 1024 for incurring a scan charge (data read or data generation charge) and a deposit; and a controller 1025 for collectively controlling these apparatus and transmitting and receiving data to and from the Internet 101.

An interface unit may be provided for reading data from a storage medium such as a floppy disk and a compact disk. The printer 1023 is not necessarily required. It is not necessary that the panel unit 1022 is a display with a touch panel, and a discrete display may be provided independently from the panel unit 1022.

Reference numeral 103 represents a data storage server. The data storage server 103 receives image data and a data storage ID transmitted from the data transmission apparatus 102, and stores them in an internal storage unit. By referring to the data storage ID, the data storage server deals with an inquiry request of image data from another computer and a request of deleting data stored in the internal storage unit. The data storage server also performs electronic on-line settlement for refunding a deposit.

Reference numeral 104 represents a personal computer (PC) functioning as a client terminal. A mail client program runs on this personal computer 104.

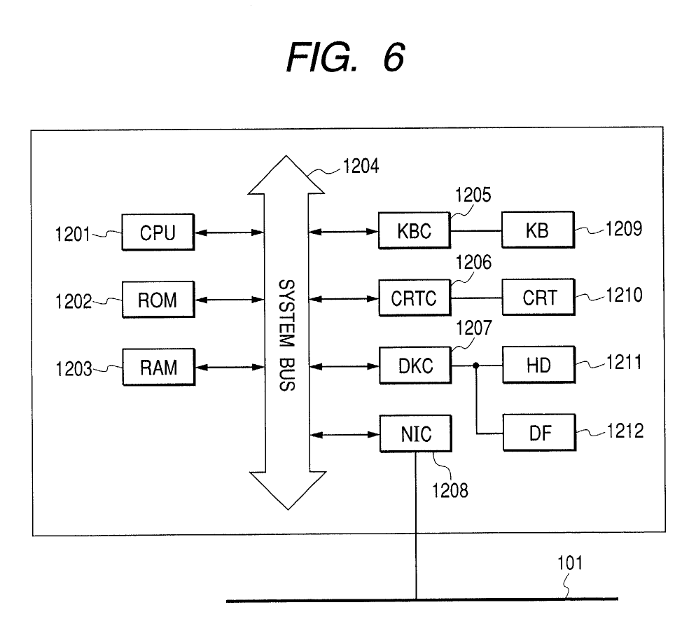

FIG. 6 is a diagram showing an example of the structure of the data storage server 103.

Referring to FIG. 6, the data storage server 103 has a CPU 1201 which collectively controls components connected to a system bus 1204 by executing a control program stored in a ROM 1202, hard disk (HD) 1211 or a control program supplied from a floppy disk (FD) 1212. CPU 1201 and the control program stored in ROM 1202, hard disk (HD) 1211 or the like can execute each process of the embodiment to be described later.

Reference numeral 1203 represents a RAM which functions as a main memory, a working area and the like of CPU 1201.

Reference numeral 1205 represents a keyboard controller (KBC) which controls inputs from a keyboard (KB) 1209 and the like.

Reference numeral 1206 represents a CRT controller (CRTC) which controls a CRT display (CRT) 1210.

Reference numeral 1207 represents a disk controller (DKC) which controls accesses to the hard disk (HD) 1211 and floppy disk (FD) 1212. The hard disk (HD) 1211 stores a boot program (for starting an execution (operation) of hardware and software of a personal computer), a plurality of applications, user files, network management programs and the like.

Reference numeral 1208 represents a network interface card (NIC) which allows bidirectional data transmission to another network apparatus or PC via the Internet 101.

The data transmission apparatus 102 and personal computer 104 may be configured to have the structure similar to that shown in FIG. 6.

In the data transmission apparatus 102, the scanner 1021 and charging unit 1024 are connected to the system bus 1204, and when necessary the printer 1023 is connected to the system bus. The keyboard (KB) 1209 and CRT display (CRT) 1210 constitute the panel unit 1022 with a touch panel display. CPU 1201 and network interface card 1208 constitute the controller 1025.

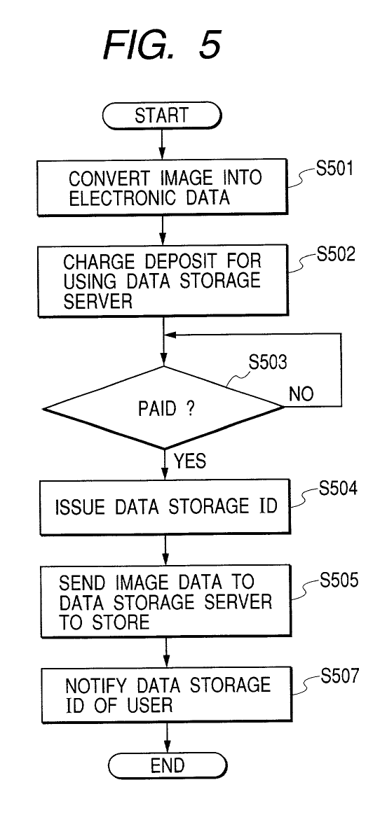

A flow chart shown in FIG. 5 illustrates the procedure to be executed by the data transmission apparatus 102. This flow chart corresponds to a program to be executed by CPU 1201 of the data transmission apparatus 102. CPU 1201 as a microcomputer reads this program from RAM 1203 to execute the processes illustrated in FIG. 5. This program is stored in the floppy disk (FD) 1212, and CPU 1201 reads this program from FD 1212 to RAM 1203. This floppy disk is a storage medium from which CPU 1201 can read the program. CPU 1201 may receive this program from the Internet 101 and stores it in RAM 1203.

First, at Step S501, the scanner 1021 of the data transmission apparatus 102 scans an image and generate electronic data. Thereafter, the flow advances to Step S502 whereat a process of incurring a deposit is executed, the deposit being charged when a user uses the data storage server 103.

The deposit is a charge determined for each data. A deposit settlement method may use cash, a credit card or electronic settlement. The deposit incurring process will be later described with reference to FIG. 4.

If it is judged at Step S503 that the deposit was paid, the flow advances to Step S504 whereat a data storage ID is issued.

The issued data storage ID is only one ID unique in the world. Namely, a data storage ID is generated by using a physical interface address of a network adapter of the data transmission apparatus 102 and an ID generation time, so that it can be guaranteed that the generated ID is only one ID unique in the world.

Next, the controller 1025 of the data transmission apparatus 102 operates to transmit image data to, and store it in, the data storage server 103 (Step S505).

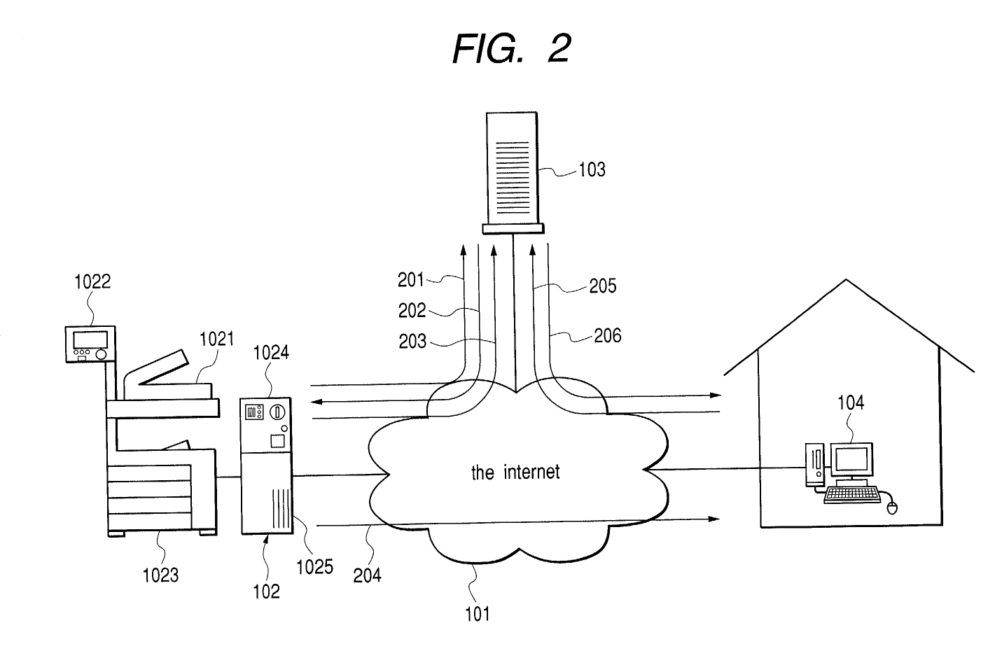

The process at Step S505 will be described with reference to FIG. 2. FIG. 2 shows a data flow in the data transmission system of this embodiment.

In a first process 201, the data transmission apparatus 102 requests the data storage server 103 to transmit a cipher key. In response to this request, the cipher key is transmitted and received in a second process 202. Then, the data transmission apparatus 102 enciphers the issued data storage ID by using the cipher key received from the data storage server 103. In a third process 203, a set of image data and enciphered data storage ID is transmitted to the data storage server 103.

Instead of issuing the data storage ID by the data transmission apparatus 102, it may be issued by the data storage server 103 and the cipher key and the data storage ID are transmitted to the data transmission apparatus 102 in the second process 202. In this modification, the data storage server 103 can issue a proper serial number as the data storage ID.

The data storage server 103 first deciphers the enciphered data storage ID received in the third process 203. The data storage server 103 stores the image data in the hard disk HD 1211 in the format capable of searching the image data by using the deciphered data storage ID as a search key.

Next, the data transmission apparatus 102 notifies a user of the data storage ID (Step S507). This notice is displayed on the panel unit 1022 by allowing the user to select either receiving the data storage ID as an e-mail or receiving it as characters printed out by the printer 1023, respectively in a fourth process 204. If the data storage ID is printed out without using an e-mail, a danger that the data storage ID is known to the third party can be avoided.

The user can acquire the image data from the data storage server from any location and at any timing.

Instead of executing the deposit charging process at Steps S502 and S503 between Steps S501 and S504, the deposit charging process may be executed between the second and third processes 202 and 203 shown in FIG. 2. In this modification, after Step S501 is executed, Step S504 is executed. Also in this modification, the data transmission apparatus 102 requests data storage in the first process 201, whereas the data storage server 103 instructs deposit charge and transmits the cipher key in the second process 202. Upon reception of an instruction of deposit charge, the data transmission apparatus 102 executes Steps S502 and S503, and after the confirmation of deposit payment, executes the third process 203. In this modification, the data storage server 103 may determine an amount of the deposit and notify the data transmission apparatus 102 of the deposit amount.

FIG. 4 is a diagram showing a dialogue displayed on the panel unit 1022 of the data transmission apparatus 102, the dialogue being used for selecting a deposit payment method and a method of notifying the data storage ID to a user.

If cash is designated as the deposit payment method, cache is collected by the charging unit 1024 of the data transmission apparatus 102. If a credit card is selected, a dialogue for urging the user to enter the credit card number is displayed. After the user enters the credit card number, the charge is paid from the credit card company.

If electronic money is selected, the process changes with the type of electronic money to be used. If electronic money of a prepaid type or a network type is used, an electronic money ID is entered to pay the charge through electronic settlement.

If electronic money of an IC card type is used, an IC card reader mounted on the charging unit 1024 is used. Namely, as the electronic money IC card is inserted into the IC card reader, the charge is paid through electronic settlement.

Next, a procedure of acquiring data from the data storage server 103 will be described.

First, in a fifth process 205, by using an e-mail a user transits a command mail from the personal computer 104 to the data storage server 103.

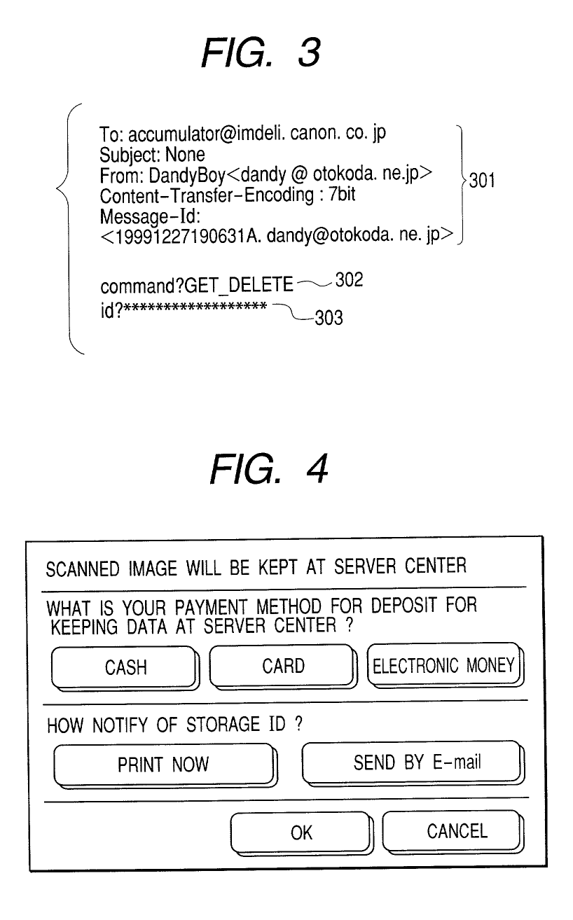

The contents of the command mail are shown in FIG. 3. The contents of the command mail include, in addition to a usual e-mail header 301, information 302 of designating the command type and information 303 of designating the data storage ID entered in the main text field. Although the data storage ID designating information 303 is shown by a succession of * in FIG. 3, the data contained in the main text field of the e-mail is the same at the data storage ID notified at Step S507 shown in FIG. 5.

The command includes GET for requesting acquisition of image data, DELETE for requesting deletion of data stored in the data storage server 103, and GET_DELETE for requesting both GET and DELETE.

Upon reception of a command mail from a user, the data storage server 103 performs the operation matching the contents designated by the command information 302, relative to the image data recognized by the data storage ID designating information 303.

Namely, if the command information 302 is GET, as a return mail for the command mail, an e-mail appended with image data is transmitted to the personal computer 104 of the user. If the command is DELETE, the image data is deleted and a deposit refunding process is executed.

The deposit refunding process is performed by issuing an ID of network type electronic money. This electronic money ID is transmitted to the user as a return mail of the command mail. This electronic money has a value same as the deposit paid when the data was stored. At Step S502 shown in FIG. 5, an e-mail address of the refund destination of the deposit may be entered to transmit the electronic money ID of the deposit to the e-mail address when the image data is deleted.

Data to be stored in the data storage server 103 is not limited only to scanned image data, but any data stored beforehand in a storage medium and input to the data transmission apparatus 102 may also be used.

In the above description, data storage is performed by the data transmission apparatus 102, whereas data acquisition is performed by the personal computer 104. Data storage may be performed by the personal computer 104. In this case, a deposit is transferred from the bank account of a user, and a refund of the deposit is transferred to the bank account. This bank account number is entered from the keyboard 1209 at Step S502 shown in FIG. 5.

It is not always necessary to refund all the deposit, but after a predetermined data storage period, a portion of the deposit may be collected as a data keeping charge to reduce the amount of the refund. This embodiment will be described in the following.

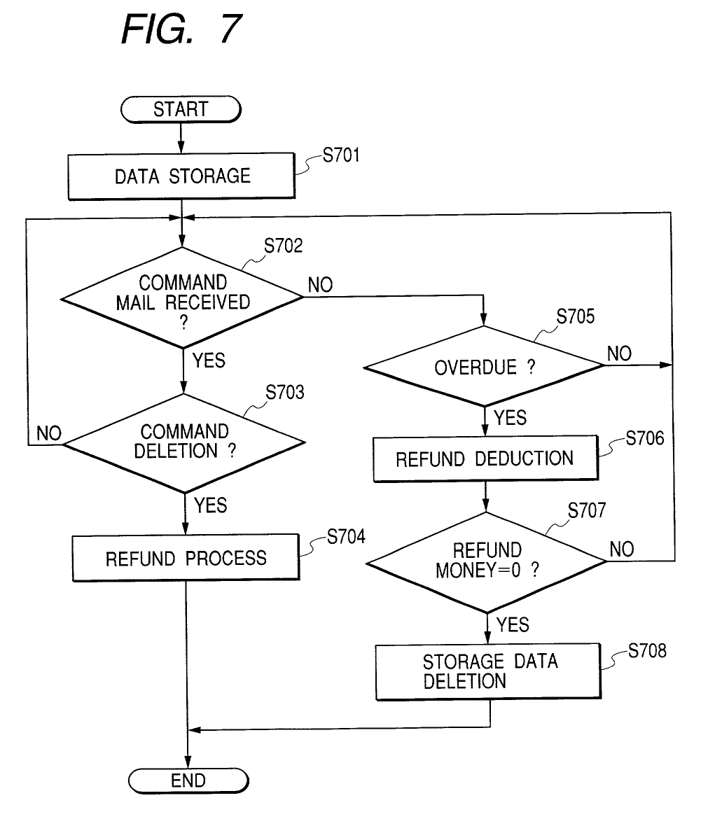

FIG. 7 is a flow chart illustrating a process of determining a refund amount, the process to be executed by the data storage server 103. This flow chart corresponds to a program to be executed by CPU 1201 of the data storage server 103. CPU 1201 as a microcomputer reads this program from RAM 1203 to execute the process shown in FIG. 7. This program is stored in the floppy disk (FD) 1212, and CPU 1201 reads this program from FD 1212 to RAM 1203. This floppy disk is a storage medium which stores the program in the format readable by CPU 1201. CPU 1201 may receive this program from the Internet 101 and store it in RAM 1203.

After image data is stored in the data storage server 103 at Step S701, it is checked at Step S702 whether there is any command mail sent from the user.

If the command mail arrives, it is checked at Step S703 whether the command contains DELETE. If contains, at Step S704 the image data designated by the DELETE command is deleted from the hard disk 1211 and a refunding process is executed. The hard disk 1211 stores the image data together with a compensation money amount for the image data. CPU 1201 operates to pay back the compensation money amount. The refunding process is performed in the manner described above. Processing the image data is not necessary to be performed at the same time when the refunding process is executed, but it may be performed at any later time suitable for the server 103.

If the command mail contains GET, as a return mail of the command mail, an e-mail appended with the image data designated by the command is transmitted to the personal computer 104 of the user.

If the command mail does not arrive at Step S702, it is checked at Step S705 whether the data keeping period exceeds a predetermined data keeping period. This check whether the data keeping period exceeds the predetermined data keeping period is performed for each stored data.

If in excess of the predetermined period, at Step S706 a calculation of reducing the money to be paid back at Step S704 is executed. The hard disk 1211 stores the image data together with the compensation money amount of the image data. Step S706 reduces this compensation money amount. This reduction calculation is determined by a data keeping period. For example, the pay-back money is not reduced if the data keeping period is one week or shorter. The pay-back money is reduced by 10% after the lapse of one week, thereafter, it is reduced by 10% by each week until the lapse of 10 weeks. This money reduction may be determined from the data keeping period and the data capacity.

It is confirmed at Step S708 whether the pay-back money is not zero. If zero, the stored data is deleted to terminate the process. Instead of confirming at Step S708 whether the pay-back money is zero, it may be confirmed whether the current time corresponds to a storage data deletion period, and if it corresponds to the storage data deletion period, the stored data is deleted. If the storage data deletion period is 20 weeks, the data is not deleted and can be acquired before the lapse of 20 weeks, although in the above-described example, the pay-back money is zero after the lapse of 10 weeks. If the command DELETE is received after 10 weeks and before 20 weeks, the pay-back money at Step S704 is zero.

The deposit is not necessary to be a fixed value, but it may be determined variably in accordance with the data capacity and keeping period.

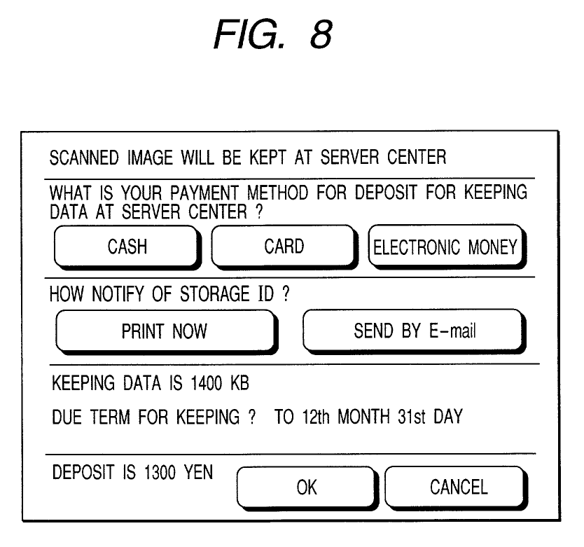

FIG. 8 is a diagram showing a dialogue to be used for changing a deposit, the diagram corresponding to a modification of that shown in FIG. 4.

At Step S502 shown in FIG. 5, when the deposit is charged, the keeping period can be changed by using the selection dialogue shown in FIG. 8 to thereby charge a deposit in accordance with the set keeping period and data amount. Namely, a unit deposit to be charged for keeping data of a unit amount (e.g., 100 KB) one day is preset. By multiplying the amount of data to be kept (in the example shown in FIG. 8, 1400 KB) and the number of keeping days by the unit deposit, the total deposit can be obtained (in the example shown in FIG. 8, 1300 Yen). This deposit calculation may be made either by the data transmission apparatus 102 or by the data storage server 103. If the data storage server 103 makes this calculation, the deposit is calculated at Step S701 shown in FIG. 7 and notified to the data transmission apparatus 102, and if the deposit is paid, the data is stored.

A set keeping period together with the image data is transmitted to the data storage server 103 at Step S505. The data storage server 103 automatically deletes the data whose keeping period becomes overdue, and at the same time executes the deposit refunding process. This refunding process may repay all the deposit or reduce the deposit in accordance with the keeping period.

If all the deposit is paid back, after the data storage server 103 confirms at Step S705 shown in FIG. 7 that the keeping period is overdue (in the example shown in FIG. 8, December 31), the data storage server 103 deletes the image data whose keeping period is overdue, from the hard disk 1211, and all the deposit is paid back. In this case, reducing the deposit at Step S706 is not performed. If there is a space of the hard disk 1211, the image data may not be deleted even if the keeping period is overdue. In this case, the data storage server 103 deletes the overdue image data at any time after the keeping period.

If the deposit is reduced in accordance with the keeping period, the pay-back money becomes zero after the lapse of the period set at Step S502 shown in FIG. 5. In this case, the pay-back money is reduced each day at Steps S705 and S706 shown in FIG. 7 so that the pay-back money becomes zero when the keeping period ends. A judgement at Step S707 whether the pay-back money is zero is the same as a judgement whether the keeping period ends.

In the embodiments, a deposit is charged when data is stored. In another modification, the data storage server 103 asks the data owner at a predetermined timing whether the already stored data is to be stored in succession. If the data owner desires to store the data, a deposit is further charged. In this modification, the data storage server 103 stores the image data and information of the data owner (e.g., a mail address of the personal computer 104) in the hard disk 1211 to ask at a predetermined timing the data owner for the confirmation (e.g., to send a mail to the personal computer 104). If it is confirmed that the data owner desires to continue data storage, the data storage server 103 executes a deposit charging process (e.g., transfers the deposit from the bank account of the data owner).

For example, the deposit may be made free within one week after data storage, and if the data owner desires to keep the data over one week, the deposit may be required to be paid in one week.

The data storage server 103 may provide services such as data conversion and converted data storage which are difficult for a personal computer provide such services. In this case, such data conversion service may be charged.

The present invention may be applied to data other than scanned image data.

For example, moving image data generated by a video camera or audio data generated by a microphone may be stored in the data storage server 103. A deposit for this data storage may also be charged. Further, a combination of scanned image data, moving image data and audio data may also be stored in the data storage server 103. A deposit for this data storage may also be charged.

The data transmission apparatus 102 may be installed at a public area. The reader of the data transmission apparatus 102 reads data recorded in a specific storage device which is difficult to be owned by an individual person, so that the data can be supplied via the data storage server 103 to the personal computer 104 of the user.

If data prepared beforehand and temporarily stored in the data transmission apparatus 102, instead of the data generated by the scanner 1021, is to be stored in the data storage server 103, a deposit for this data storage may also be charged. Further, if scanned data and data prepared beforehand and temporarily stored in the data transmission apparatus 102 are both to be stored in the data storage server 103, a deposit for this data storage may also be charged.

The data transmission system of this invention may be applied to services such as video mail distribution services using a video camera installed in a public area.

Since anybody can use a data input apparatus installed in a public area, if it is illicitly used for mail bombs or the like, it is difficult to identify a person who transmitted data. However, the invention can prevent such illicit use in advance.

The invention is also applicable to a system having a plurality of apparatuses (e.g., a host computer, an interface apparatus, a reader, a printer, an external storage unit, a video camera, a microphone and the like) or to a single apparatus.

The scope of the invention contains also the case wherein software program codes realizing the function of each embodiment described above are supplied to a computer (CPU or MPU) of the apparatus or system connected to various devices realizing the embodiment function, and the computer operates the devices in accordance with the stored programs.

In this case, the software program codes themselves realize the embodiment function. Therefore, the program codes themselves and means for supplying the computer with the program codes, e.g., a storage medium storing the program codes, constitute the present invention.

The storage medium for storing such program codes may be a floppy disk, a hard disk, an optical disk, a magneto optical disk, a CD-ROM, a magnetic tape, a nonvolatile memory card, a ROM or the like.

It is obvious that the program codes are included in the embodiment of the invention, wherein not only the computer executes the supplied program codes to realize the embodiment function but also the program codes in cooperation with an OS (operating system) running on the computer or with another application or the like realize the embodiment function.

It is obvious that the scope of the invention also contains the case wherein the functions of each embodiment can be realized by writing the program codes into a memory of a function expansion board inserted into a computer or of a function expansion unit connected to the computer, and thereafter by executing a portion or the whole of actual processes by a CPU of the function expansion board or function expansion unit.

The present invention has been described in connection with the preferred embodiments. The invention is not limited only to the above embodiments. It is apparent that various modifications can be made without departing from the scope of claims.

What is claimed is:

1. A data storage apparatus comprising:
storage means for storing data; and
refunding means for paying back a deposit charged for data storage by said storage means.

2. A data storage apparatus according to claim 1, wherein said refunding means pays back the deposit in response to an instruction of deleting the data stored in said storage means.

3. A data storage apparatus according to claim 1, wherein said refunding means pays back the deposit in accordance with a data storage period.

4. A data storage apparatus according to claim 1, wherein said storage means includes transmitting means for transmitting data via a network.

5. A charging apparatus comprising:
charging means for charging a deposit for storing data in a storage apparatus; and
transmitting means for transmitting data to the storage apparatus.

6. A charging apparatus according to claim 5, wherein said charging means charges the deposit in accordance with a data storage period.

7. A charging apparatus according to claim 5, wherein said transmitting means transmits data to the storage apparatus via a network.

8. A data storage apparatus comprising:
storage means for storing data; and
charging means for charging a deposit for storing data in said storage means.

9. A data storage apparatus according to claim 8, wherein said charging means charges the deposit in accordance with a data storage period.

10. A data storage apparatus according to claim 8, wherein said storage means includes transmitting means for transmitting data via a network.

11. A data storage method comprising steps of:
storing data; and
refunding a deposit charged for data storage.

12. A data storage method according to claim 11, wherein said refunding step pays back the deposit in response to an instruction of deleting the stored data.

13. A data storage method according to claim 11, wherein said refunding step pays back the deposit in accordance with a data storage period.

14. A data storage method according to claim 11, wherein said storing step includes a transmitting step of transmitting data via a network.

15. A charging method comprising steps of:
charging a deposit for storing data in a storage apparatus; and
transmitting data to the storage apparatus.

16. A charging method according to claim 15, wherein said charging step charges the deposit in accordance with a data storage period.

17. A charging method according to claim 15, wherein said transmitting step transmits data to the storage apparatus via a network.

18. A data storage method comprising steps of:
storing data; and
charging a deposit for storing data.

19. A data storage method according to claim 18, wherein said charging step charges the deposit in accordance with a data storage period.

20. A data storage method according to claim 18, wherein said storing step includes a transmitting step of transmitting data via a network.

21. A data storage program comprising steps of:
storing data; and
refunding a deposit charged for data storage.

22. A data storage program according to claim 21, wherein said refunding step pays back the deposit in response to an instruction of deleting the stored data.

23. A data storage program according to claim 21, wherein said refunding step pays back the deposit in accordance with a data storage period.

24. A data storage program according to claim 21, wherein said storing step includes a transmitting step of transmitting data via a network.

25. A charging program comprising steps of:
charging a deposit for storing data in a storage apparatus; and
transmitting data to the storage apparatus.

26. A charging program according to claim 25, wherein said charging step charges the deposit in accordance with a data storage period.

27. A charging method according to claim 25, wherein said transmitting step transmits data to the storage apparatus via a network.

28. A data storage program comprising steps of:
storing data; and
charging a deposit for storing data.

29. A data storage program according to claim 28, wherein said charging step charges the deposit in accordance with a data storage period.

30. A data storage program according to claim 28, wherein said storing step includes a transmitting step of transmitting data via a network.

31. A data storage service comprising steps of:
storing data; and
refunding a deposit charged for data storage.

32. A data storage service according to claim 31, wherein said refunding step pays back the deposit in response to an instruction of deleting the stored data.

33. A data storage service according to claim 31, wherein said refunding step pays back the deposit in accordance with a data storage period.

34. A data storage service according to claim 31, wherein said storing step includes a transmitting step of transmitting data via a network.

35. A data storage service comprising steps of:
storing data; and
charging a deposit for storing data.

36. A data storage service according to claim 35, wherein said charging step charges the deposit in accordance with a data storage period.

37. A data storage service according to claim 35, wherein said storing step includes a transmitting step of transmitting data via a network.
